(19) United States
(12) Patent Application Publication
(10) Pub. No.: US 2023/0219798 A1
(43) Pub. Date: Jul. 13, 2023

(54) Water bottle cap puncturing device

(71) Applicant: Lucien Anthony Hummel, Brighton (CA)

(72) Inventor: Lucien Anthony Hummel, Brighton (CA)

(21) Appl. No.: 18/162,881

(22) Filed: Feb. 1, 2023

(51) Int. Cl. B67B 7/00

(52) U.S. Cl. CPC B67B 7/24

(57) ABSTRACT

The water bottle cap puncturing device is a device and method to quickly and easily convert a standard 500 ml non-pressurized food grade water bottle into a liquid spray dispensing or liquid filtration device. The device consists of a metallic circular cap-like structure, with an array of pins of varying sizes. When the device is attached the cap of the bottle, inverted, and then struck on or by a hard surface, the pins penetrate the bottle, thus perforating the cap and converting the bottle into a liquid spray dispensing or liquid filtration device.

### BACKGROUND OF THE INVENTION

This invention relates to the field of liquid container puncturing or perforating devices. Specifically, this tool is used to puncture or perforate the approximately 30 mm diameter plastic cap of a standard 500 ml non-pressurized water bottle, such as those readily purchased at a supermarket, convenience store or distributed following disasters.

The idea originated when, while preparing food on a BBQ, small flares would appear, and there was a need for a ready means to douse these flare-ups with a food-grade solution. The solution appeared when the inventor began puncturing the cap of a standard food grade water bottle with a pin. He then realized that a simple device with several similarly sized attached pins would perform the task quickly and easily.

### DESCRIPTION OF THE PRIOR ART

As discussed below, there appears to be no prior art disclosing a water bottle cap puncturing, perforating or piercing device that makes several (13) perforations simultaneously, and converts said water bottle into a device capable of discharging its contents, when squeezed, as a dispersed spray. Likewise, there appears to be no prior art disclosing a water bottle cap puncturing, perforating or piercing device that converts said water bottle into a device capable of acting as a portable liquid filtration device.

The Packer Patent (U.S. Pat. No. 1,689,047, 1927), discloses a device capable of puncturing the cap of a glass milk bottle with a single hole into which can be inserted a straw. Its purpose however, is not to convert the milk bottle into a device capable of spraying its contents.

The Neally Patent (U.S. Pat. No. 2,567,344, 1950), discloses two devices capable of puncturing an open neck glass bottle with a crown cap, but require a pressurized or carbonized liquid, and only with a single perforation and only for use as a fire extinguisher. Rendition #1 requires the device to be permanently affixed to a solid surface, while rendition #2 requires that the device be affixed to the bottle.

Likewise, the Neff Patent, (U.S. Pat. No. 1,154,718, 1915), is capable of puncturing an open neck bottle with a crown cap, and only with a single perforation and only for use with pressurized or carbonized liquid. An additional feature of the Neff device is that it also removes the bottle cap which the currently disclosed device does not.

The Keys Patent (U.S. Pat. No. 2,390,309, 1944) discloses a device that that can pierce light metals, cloth etc. in order to create a vent so as to enable the free flow of air or liquids, and allows the user to determine the size the opening. But again, the device creates only one perforation at a time.

Likewise, the Pritchard Patent (U.S. Pat. No. 8,387,264 B1, 2013) discloses a device that that can pierce the light metal of beer can in the shape of a shotgun shell, but again makes only one perforation and intended for one specific use: the “shotgunning” of a can of beer.

Finally, the Roefs Patent (U.S. Pat. No. 9,889,958, 2018) discloses a device whose purpose is to puncture vacuum sealed lids of cans, jars, bottles. Unlike the disclosed device, it is much larger in size, and its single, exposed, relatively large pin differs markedly from the currently disclosed device's 13 pins, whose sizes range in height from 5 mm, 7 mm and 9 mm, having 1 mm at the base, and 6°, 5° and 4° from centerline respectively.

While the above described devices fulfill their respective and specific requirements, they do not describe a device that can with one application of force, or “punch,” puncture, perforate or pierce the 27.8 mm diameter plastic cap of a standard 500 ml non-pressurized water bottle with 13 pin-prick holes that convert the bottle into a device capable of, when squeezed, spraying water in a dispersed pattern that can then be used in a myriad of applications.

### SUMMARY OF THE INVENTION

The water bottle cap puncturing device, is a portable tool used to puncture or perforate the approximately 30 mm diameter plastic cap of a standard 500 ml non-pressurized water bottle, such as those readily purchased at a convenience store, a supermarket, or distributed following disasters. It is an object of the invention that when the bottle cap is perforated with 13 pin-prick size holes, it is converted into a device capable of, when squeezed, dispersing water, or water based liquids, in a spray pattern for use in several applications: dousing small fires or flares, typically during the act of BBQing, cleaning said BBQ or other objects, watering plants, showering, or with a fine screen or similar membrane inserted into the bottle cap, filtering dirty or brackish water. Its possible uses are manifold.

These features and benefits of the water bottle puncturing device will be apparent to those of normal skill in the art upon review of the following detailed description of presently preferred, but nonetheless illustrative, embodiments of the water bottle puncturing device, when combined with the accompanying drawings. In this respect, before explaining the current embodiments of the water bottle puncturing device in detail, it is to be understood that the water bottle puncturing device is not limited in its applications to the details of construction and design of the components set forth in the following description or illustrations. Those skilled in the art will appreciate that the concept of this disclosure may be presented as a basis for the design of other structures, methods, and systems for similar purpose.

It is a further object of the invention that because the water bottles are considered food-grade, the contents can also be replaced with other food-grade liquids such as vinegar or soya sauce. It is another object of the invention that in addition, the bottle can be filled with other substances such as cleaning liquids that require application by spray: bleach for example. Conversely, it is another object of the invention that a fine screen or membrane can be inserted into the bottle cap to be used as a filtration device. Dirty or brackish water can be placed into the bottle whose cap can be used as a filter to remove coarse impurities using applied force, or simply gravity. It is yet another object of the inventions that using gravity, the device can be used as a ‘slow drip’ plant watering apparatus.

It is therefore important that the claims be regarded as including such equivalent construction insofar as they do not depart from the spirit and scope of the water bottle puncturing device. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in, and constitute a part of this specification, illustrate embodiments of the invention and together with the description, serve to explain the principles of the invention.

FIG. 1 illustrates a top, isometric “see-through,” or wire view of the water bottle cap puncturing device with all of its elements in view in the open position.

FIG. 2 illustrates a top, isometric solid, or shaded view of the water bottle cap puncturing device in the open position.

FIG. 3 illustrates a top, isometric solid, or shaded view of the water bottle cap puncturing device in the closed position.

FIG. 4 illustrates a top view of the water bottle cap puncturing device in the open position.

FIG. 5 illustrates a bottom view of the water bottle cap puncturing device in the open position.

FIG. 6 illustrates a side view of the water bottle cap puncturing device in the closed position.

FIG. 7 illustrates a front view of the water bottle cap puncturing device in the open position.

FIG. 8 illustrates a side view of the water bottle cap puncturing device in the open position.

FIG. 9 illustrates an isometric view of the base of the water bottle cap puncturing device.

FIG. 10 illustrates an isometric view of the base and the perforating pins of the water bottle cap puncturing device.

FIG. 11 illustrates a profile view of the perforating pins of the water bottle cap puncturing device to illustrate the height differential of the pins.

FIG. 12 illustrates the first step in the water bottle cap puncturing process: aligning the device with the water bottle cap.

FIG. 13 illustrates the second step in the water bottle cap puncturing process: pressing onto, or attaching the device to the water bottle cap.

FIG. 14 illustrates the third step in the water bottle cap puncturing process: striking the water bottle with force, or “punching” on or by a hard surface.

FIG. 15 illustrates the forth step in the water bottle cap puncturing process: removing the device form the water bottle cap.

FIG. 16 illustrates the fifth and final step in the water bottle cap puncturing process: the water bottle being used as a liquid spray, or filtration device.

FIG. 17 illustrates positioning of a fine screen or membrane for placement into the water bottle cap.

FIG. 18 illustrates a fine screen or membrane having been inserted into the water bottle cap.

### DETAILED DESCRIPTION OF THE DEVICE

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Furthermore, there is no intention to be bound by any expressed or implied theory presented in the preceding technical field, background, brief summary or the following detailed description.

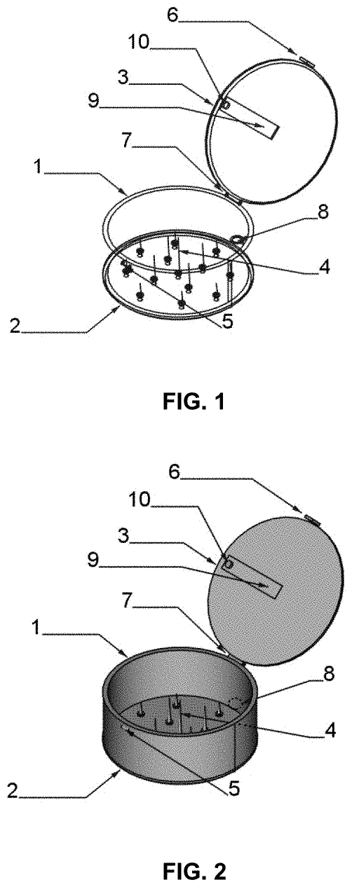

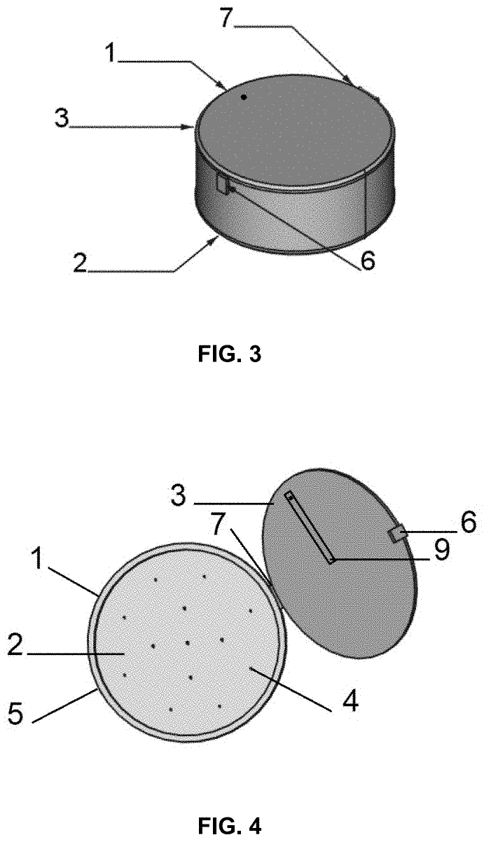

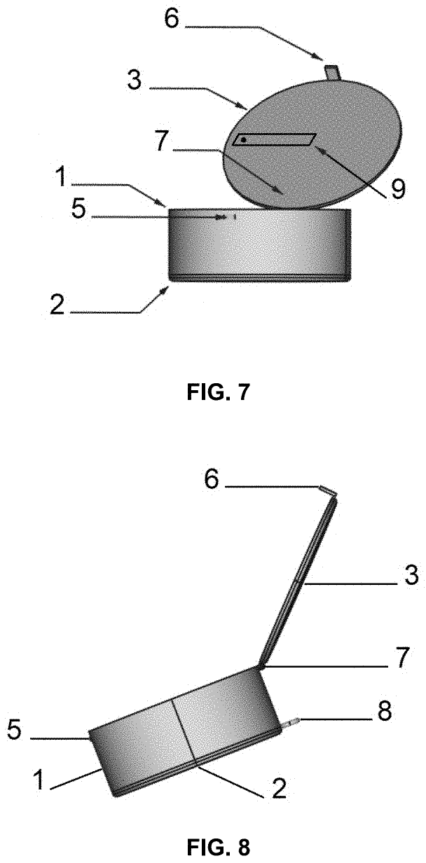

Detailed reference will now be made to the preferred embodiment of the present invention, examples of which are illustrated in FIGS. 1-11.

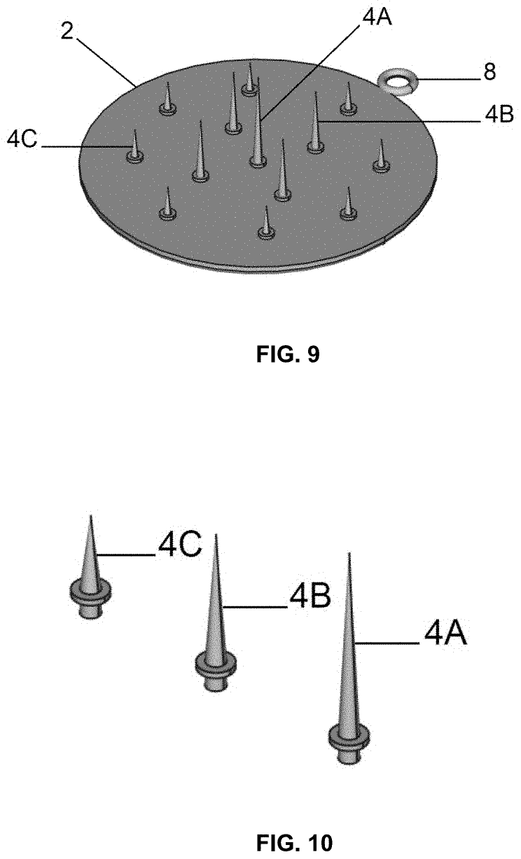

The water bottle cap puncturing device consists of a metallic (brass, aluminum or stainless steel) cylindrical case FIGS. 1-8, #1 whose exterior diameter is approximately 30.0 mm and whose interior diameter, approximately 28.5 mm, is slightly larger than the standard water bottle's cap. It has a circular metallic (brass, aluminum or stainless steel) base FIGS. 1-8, #2, FIG. 9 to which thirteen (13) conical stainless steel pins of three (3) varying sizes are attached FIGS. 1-8, #4, FIGS. 10 & 11. The thickness of the base and case, which may, or may not be one piece, is 1.5 mm; the base's exterior outside edge has a 0.5 mm fillet, or bevel. The base's exterior outside edge also has a 0.5 mm fillet, or bevel, as well as a small loop, or fob FIGS. 1-8, #8, whose exterior diameter at approximately 6 mm, allows it to be attached to a keychain.

The device has a metallic (brass, aluminum or stainless steel) protective cover FIGS. 1-8, #3, whose thickness is also 1.5 mm, and is attached to the device by a hinge, allowing it to open and close, FIGS. 1-8, #7 with a clasp FIGS. 1-8, #6 and lock FIGS. 1-8, #5. Attached to the inside of the protective cover is a spring retaining clamp FIGS. 9 & 10 measuring approximately 4 mm width by approximately 11 mm length by 0.5 mm thickness that can hold several fine metal screens. The screens have a diameter of 20 mm and fit securely into the cap of the water bottle when used as a filtration device.

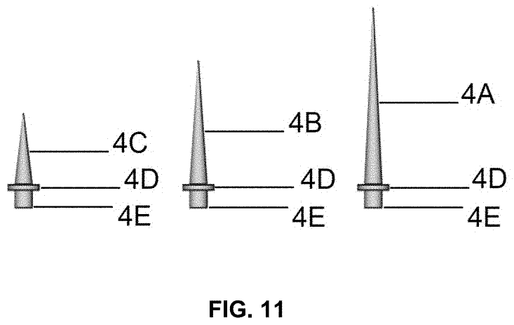

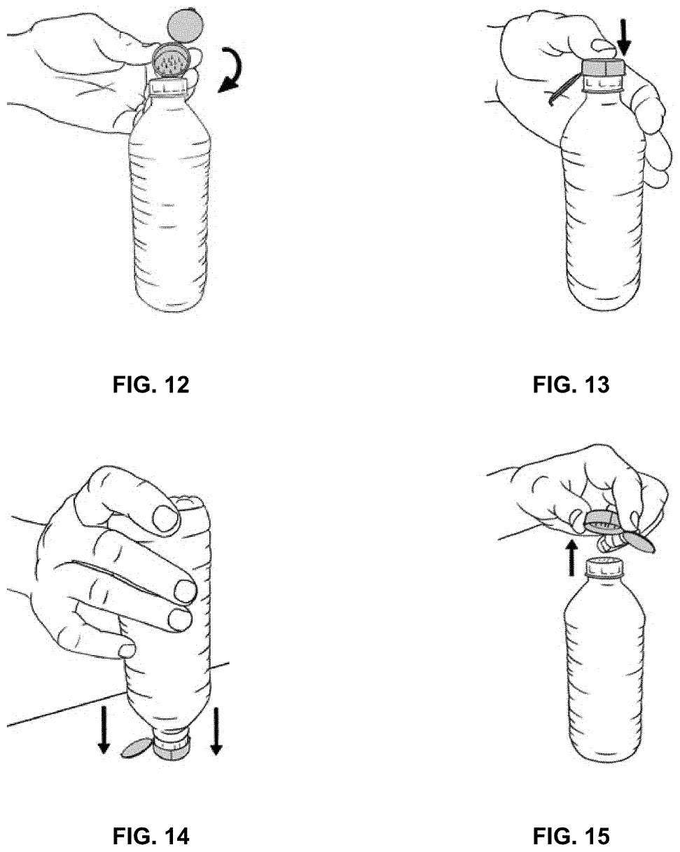

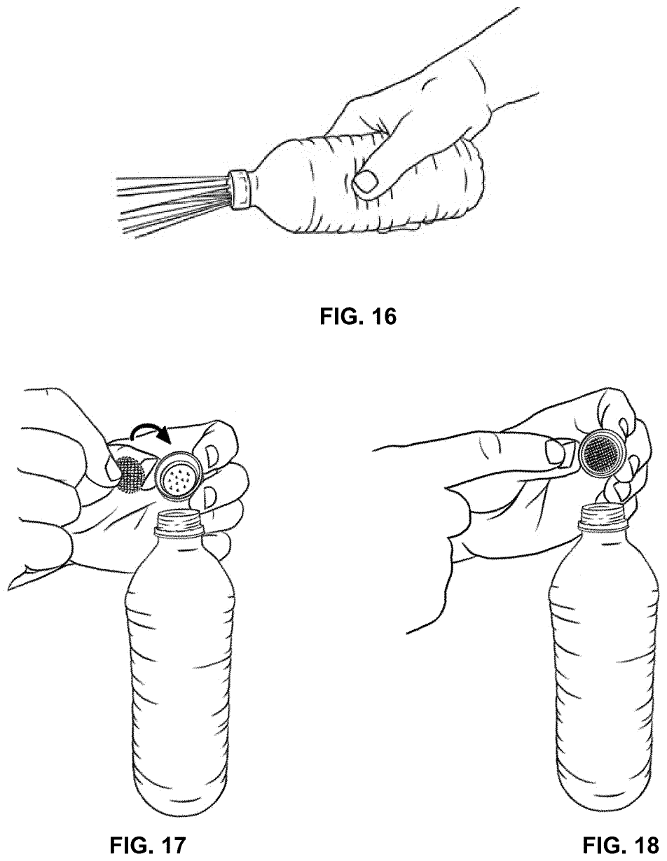

The pins FIGS. 10 and 11 attached to the base FIG. 9 are arrayed outward from the center in a concentric pattern, with the tallest being in the center, and the shortest being on the periphery. The taller size of the single center, or king pin, allows for the easy attachment of the device to the bottle cap by a simple press of the thumb or palm. The bottle is then inverted and struck, or “punched” on or by a hard surface, which forces the 12 remaining pins through the plastic cap, producing the holes.

Due to the nature of the bottle's thin, light plastic construction, were the pins all of the same height, an equal amount of force applied to each pin during the striking procedure would result in compression of the bottle to the point of damage or destruction of the bottle. However, the staggered pin-height pattern FIG. 9, distributes the force among the two remaining pins heights, thereby preventing damage to the bottle. Furthermore, the largest number of pins (8), are situated at the periphery FIG. 9, whose closer proximity to the lip of the bottle provides more support where the greatest amount of force to the bottle cap is applied. The conical shape of the pins from tip to base at shallow angles allows for the easy removal of the device, which leaves 13 pin-prick size holes in the bottle cap. When squeezed, this forces the contents of the bottle out in a spray pattern. The number (13) and size of hole(s) (<1 mm), has been determined by extensive experimentation to be the ideal balance between liquid flow, liquid use and force application, when using liquids that are the general consistency of water.

The generic structure of a (1) pin consists of 3 sections: cone FIG. 11, 4C, 4B, 4A, torus, or anchoring ring, FIG. 11, 4D, and cylinder FIG. 11, 4E. The conical sections of the pins vary in height FIG. 11, 4C=5 mm, 4B=7 mm, 4A=9 mm, as do their angles FIG. 11, 4C=6°, 4B=5°, 4A=4° from centreline. The base, or largest diameter of the conical section FIG. 11, 4C, 4B, 4A, is 1 mm, as is the diameter of the cylinder FIG. 11, 4E; the torus FIG. 11, 4D is 2 mm in diameter.

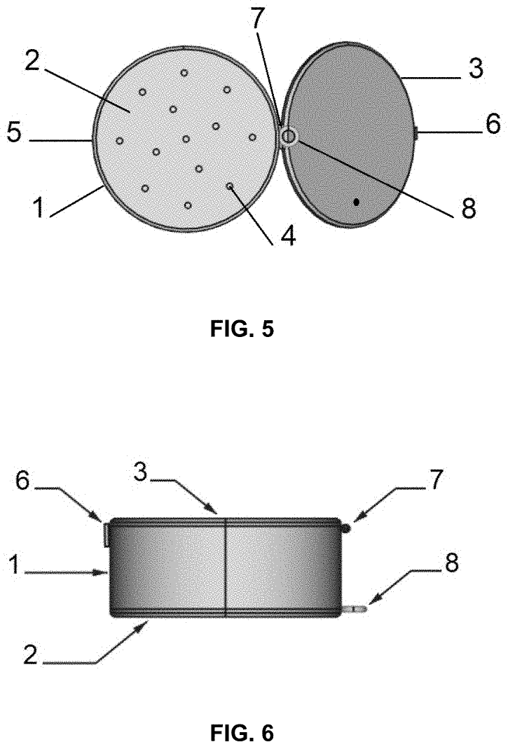

The pins are attached to the base FIG. 9 by virtue of thirteen holes in the base through which the cylinders of the pins are inserted. The cylinder portion of the pins FIG. 11, 4E is a constant 1.5 mm in height. Once the cylinder portion of the pin is inserted into the base, the protruding portion FIG. 5 is then stamped to secure it in place, while the torus acts as a counterforce block and support.

I claim:

1. A portable water bottle cap puncturing device comprising a cylindrical case attached to a circular base with a protective cover with lock and clasp where to the base are attached thirteen (13) pins of varying sizes, and a loop or fob for attachment to a keychain, lanyard, or other such small item aggregating device; wherein the number, height or size, and placement of the said pins is the ideal number and placement to achieve the optimum balance between liquid volume and liquid flow; wherein the three specific heights, or sizes of the staggered pin-height pattern distributes the force among the three pin heights, thereby preventing damage to the bottle; wherein the largest number of pins (8), are situated at the periphery of the base whose closer proximity to the lip of the bottle provides more support where the greatest amount of force to the bottle cap is applied; wherein the structure of a pin consisting of three (3) sections:
cone, torus, or anchoring ring, and cylinder where the conical sections' angles from centreline are constant within their respective sizes allowing for easier removal of the device and the torus' and cylinders' sections dimensions within and among their respective sizes is identical; wherein the insertion of a fine screen or membrane into the cap of the water bottle will allow the water bottle to act as a portable liquid filtration device.

2. A process or method to convert a standard 500 ml non-pressurized water bottle into a liquid spray dispensing or liquid filtration device wherein the device is aligned to the bottle; wherein the device is attached to the bottle; wherein the bottle is struck, or “punched,” on or by a hard surface; wherein the device is removed from the bottle; wherein the bottle is converted into a liquid spray dispensing device; wherein a fine screen or membrane is inserted into the cap of the water bottle and the bottle is converted into a liquid filtration device.
